(19) United States
(12) Patent Application Publication
(10) Pub. No.: US 2026/0015032 A1
(43) Pub. Date: Jan. 15, 2026

(54) ELECTRO-HYDRAULIC POWER ASSISTED STEERING ASSEMBLY FOR A VEHICLE AND METHOD OF ASSEMBLING THE SAME

(71) Applicant: ZF CV Systems Global GmbH, Bern (CH)

(72) Inventors: Sriram JAYARAMAN, Chennai (IN); Senthil DORAI RAJ, Chennai (IN); Praveen VIJAYENTHRAN, Karaikudi (IN)

(21) Appl. No.: 19/257,498

(22) Filed: Jul. 2, 2025

(30) Foreign Application Priority Data
Jul. 12, 2024 (IN) 202441053294

(51) Int. Cl. B62D 5/04; B62D 5/06

(52) U.S. Cl. CPC B62D 5/0403; B62D 5/0421; B62D 5/062

(57) ABSTRACT

An electro-hydraulic power assisted steering assembly for a vehicle is disclosed. The assembly includes a steering gear unit which in turn includes a valve housing. The valve housing has a first projection which is defined with external threads. The assembly further includes an electric motor housing which in turn has a second projection. The second projection is defined using a bore defined with internal threads corresponding to the external threads of the first projection. The external threads of the first projection of the valve housing engage with the internal threads of the second projection of the electric motor housing to couple the steering gear unit with the electric motor housing.

### CROSS REFERENCE TO RELATED APPLICATIONS

This application claims benefit to Indian Patent Application No. IN 202441053294, filed on Jul. 12, 2024, which is hereby incorporated by reference herein.

### FIELD

The present disclosure generally belongs to the technical field of automobiles. Particularly to a steering assembly of a vehicle, and in particular to a electro-hydraulic power assisted steering assembly of the vehicle and method of assembling the same.

### BACKGROUND

The steering assembly serves as the crucial interface between the driver and the vehicle, requiring precision above all. The steering assembly should also be smooth, compact, and lightweight. Additionally, the steering system must offer the driver an excellent sense of the road surface and aid in returning the wheels to the straight-ahead position. Typically, the front wheels are turned by a hand-operated steering wheel connected via the steering column. This column may incorporate several joints, enabling slight deviations from a straight line and contributing to the collapsible design that enhances driver safety in frontal crashes.

As vehicles have become heavier coupled with wider and larger tires, the effort required to manually turn the steering wheel has increased. Consequently, power-assisted steering was introduced to aid the driver. A notable benefit of power steering is speed-adjustable assistance, providing substantial help at low speeds and minimal assistance at high speeds. This feature is increasingly standard in all new vehicles.

Electro-hydraulic power-assisted steering (EHPAS) is a sophisticated system designed to enhance the steering capabilities of a vehicle. This system combines elements of both hydraulic and electric power steering, aiming to improve efficiency, control, and performance. It features an electric motor that drives a worm gear arrangement to provide power assist to the steering system. Sensors feed data on driving speed, steering torque, and steering speed to the system's control unit, which calculates steering assistance. The hydraulic pump then generates the needed hydraulic pressure, which is directed into a steering cylinder divided into two chambers by a separator piston. Depending on the steering angle and vehicle speed, the system dynamically adjusts the pressure in each chamber to provide the driver with the appropriate level of steering support. Broadly, the EHPAS system includes a steering gear unit and an electric motor housing. The electric motor housing houses an electric motor which provides power to assist in steering. The electric motor housing may be coupled to the steering gear unit through a valve housing.

The orientation of the electric motor housing may vary depending on packaging constraints of different vehicles. Conventionally, valve housing, referencing a particular orientation of the electric motor housing had to be created. This led to problems such as high tool developmental cost, material cost and potentially increasing the number of valve housing variants which is not desirable.

The information disclosed in this background of the disclosure section is for enhancement of understanding of the general background of the invention and should not be taken as an acknowledgement or any form of suggestion that this information forms the prior art already known to a person skilled in the art.

### SUMMARY

In an embodiment, the present disclosure provides an electro-hydraulic power assisted steering assembly for a vehicle, the assembly comprising: a steering gear unit comprising a valve housing, wherein the valve housing comprises a first projection, the first projection is defined with external threads; and an electric motor housing comprising a second projection, the second projection is defined using a bore with internal threads corresponding to the external threads of the first projection, wherein, the external threads of the first projection of the valve housing engage with the internal threads of the second projection of the electric motor housing to couple the steering gear unit with the electric motor housing.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an exploded view of an electro-hydraulic power assisted steering assembly of a vehicle according to an embodiment of the present disclosure;

FIG. 2a illustrates a perspective view of a valve housing of a steering gear unit of the steering assembly of FIG. 1 according to an embodiment of the present disclosure;

FIG. 2b illustrates a perspective view of a portion of electric motor housing of the steering assembly of FIG. 1 according to an embodiment of the present disclosure;

FIG. 3 illustrates an assembled view of the electro-hydraulic power assisted steering assembly according to an embodiment of the present disclosure;

FIG. 4 is a flowchart illustrating method of assembling the electro-hydraulic power assisted steering assembly according to an embodiment of the present disclosure; and

FIG. 5 illustrates a schematic view of the vehicle comprising a steering system and electro-hydraulic power assisted steering assembly according to an embodiment of the present disclosure.

### DETAILED DESCRIPTION

In accordance with an embodiment, the present disclosure provides an electro-hydraulic power assisted steering assembly for a vehicle and method of assembling the same. In the present disclosure, the steering assembly includes a unanimous valve housing that would accommodate any or 360° orientation of electric motor housing of the steering assembly, thus reducing tool developmental cost and material cost.

In one aspect of the present disclosure, an electro-hydraulic power assisted steering assembly for a vehicle is disclosed. The assembly comprises a steering gear unit which in turn comprises a valve housing. The valve housing includes a first projection which is defined with external threads. The assembly further includes an electric motor housing which in turn comprises a second projection. The second projection is defined with a bore with internal threads corresponding to the external threads of the first projection. The external threads of the first projection of the valve housing engages with the internal threads of the second projection of the electric motor housing to couple the steering gear unit with the electric motor housing.

In an embodiment of the present disclosure, the first projection and the second projection extends along a longitudinal axis of the steering gear unit and the electric motor housing respectively.

In an embodiment of the present disclosure, during the engagement of the external threads of the first projection and the internal thread of the second projection, the electric motor housing is rotatable to adjust orientation of the electric motor housing with respect to the steering gear unit.

In an embodiment of the present disclosure, the orientation of the electric motor housing ranges between 0° to 360° with respect to the steering gear unit.

In an embodiment of the present disclosure, the electric motor housing comprises an extension arm extending along a lateral axis of the electric motor housing and the extension arm is defined with a through hole to accommodate a bolt for fixing orientation of the electric motor housing with respect to the steering gear unit.

In an embodiment of the present disclosure, the bolt makes a frictional contact with the valve housing.

In an embodiment of the present disclosure, the steering assembly comprises a lock nut being configured to engage with the external threads of the valve housing and is configured to abut with a surface of the electric motor housing.

In another aspect of the present disclosure, a steering system of a vehicle comprising an electro-hydraulic power assisted steering assembly as disclosed above.

In yet another aspect of the present disclosure, a vehicle comprising an electro-hydraulic power assisted steering assembly as disclosed above.

In yet another aspect of the present disclosure, a method of assembling an electro-hydraulic power assisted steering assembly as disclosed above. The method comprises positioning the lock nut on the external threads of the valve housing of the steering gear unit, engaging the internal threads of the electric motor housing with the external thread of the valve housing. The method further includes fixing the orientation of the electric motor housing by a bolt inserted into the through hole of the extension arm of the electric motor housing and torquing the lock nut on to surface of the electric motor housing to couple the steering gear unit and the electric motor housing.

In an embodiment of the present disclosure, fixing the orientation of the electric motor housing is upon minimum thread engagement between the internal threads of the electric motor housing and the external threads of the valve housing.

The foregoing summary is illustrative only and is not intended to be in any way limiting. In addition to the illustrative aspects, embodiments, and features described above, further aspects, embodiments, and features will become apparent by reference to the drawings and the following detailed description.

The disclosure may be understood by reference to the following detailed description of an embodiment when read in conjunction with the accompanying drawings. One or more embodiments are now described, by way of example only, with reference to the accompanying drawings wherein like reference numerals represent like elements.

The figures depict embodiments of the disclosure for purposes of illustration only. One skilled in the art will readily recognize from the following description that alternative embodiments of the apparatus illustrated herein may be employed without departing from the principles of the disclosure described herein.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The following detailed description is merely exemplary in nature and is not intended to limit application and uses. Furthermore, there is no intention to be bound by any theory presented in the preceding background or summary or the following detailed description. It is to be understood that the disclosure may assume various alternative orientations and step sequences, except where expressly specified to the contrary. It is also to be understood that the specific devices or components illustrated in the attached drawings and described in the following specification are simply exemplary embodiments of the inventive concepts defined in the appended claims. Hence, specific dimensions or other physical characteristics relating to the embodiments that may be disclosed are not to be considered as limiting, unless the claims expressly state otherwise. Hereinafter, preferred embodiments of the present disclosure will be descried referring to the accompanying drawings. While some specific terms directed to a specific direction will be used, the purpose of usage of these terms or words is merely to facilitate understanding of the present invention referring to the drawings. Accordingly, it should be noted that the meaning of these terms or words should not improperly limit the technical scope of the present invention.

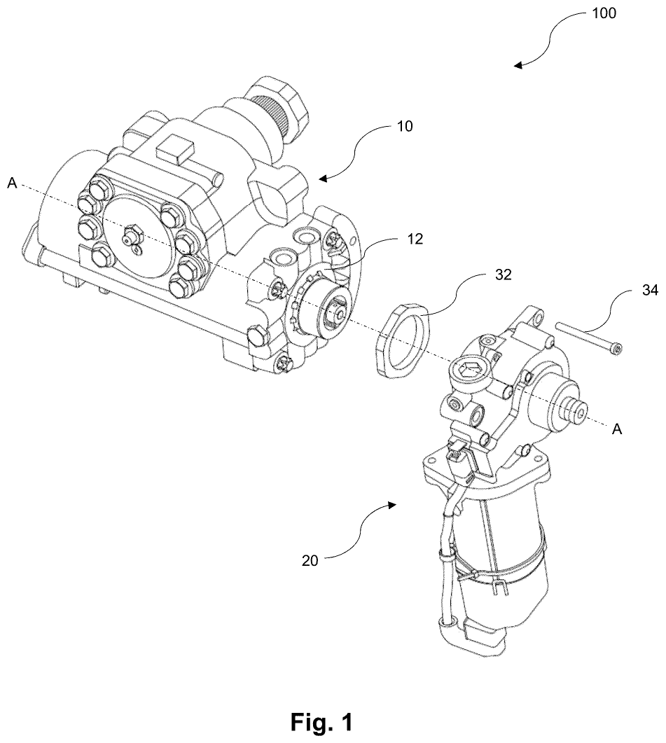

Also, it is to be understood that the phraseology and terminology used herein is for description and should not be regarded as limiting. Unless specified or limited otherwise, the terms “accommodated,” “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. It is to be understood that this disclosure is not limited to the specific devices, methods, applications, conditions, or parameters described and/or shown herein and that the terminology used herein is to describe embodiments by way of example and is not intended to be limiting of the claimed invention. Hereinafter in the following description, various embodiments will be described. For purposes of explanation, specific configurations and details are outlined to provide a thorough understanding of the embodiments. However, it will also be apparent to one skilled in the art that the embodiments may be practiced without the specific details. Furthermore, well-known features may be omitted or simplified in order not to obscure the embodiment being described. Henceforth, the steering assembly is elucidated in detail referring to FIG. 1 to FIG. 5.

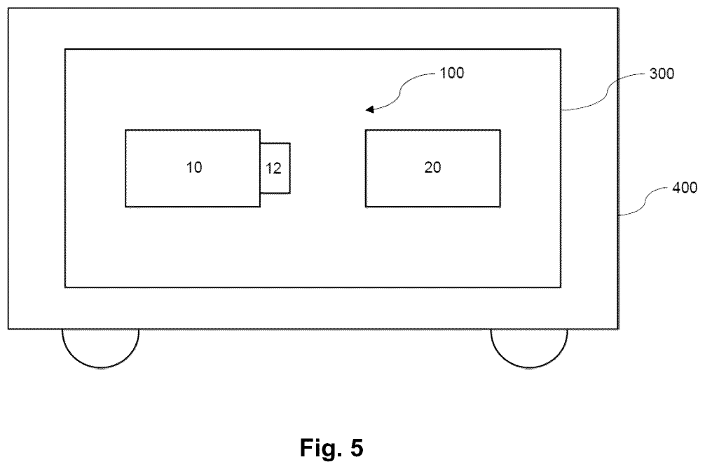

FIG. 1 illustrates an exploded view of the electro-hydraulic power assisted steering assembly 100 for a vehicle 400 (shown in FIG. 5). The electro-hydraulic power assisted steering assembly 100 may be alternatively referred herein as steering assembly 100. The vehicle 400 may typically be a commercial vehicle such as trucks, buses etc. However, type of vehicle 400 should not construed as a limitation of the present disclosure, as the present disclosure may be applicable for vehicles such as but not limited to four-wheeled vehicle including passenger cars.

The electro-hydraulic power assisted steering assembly 100 or steering assembly 100 may broadly include a steering gear unit 10 and an electric motor housing 20. The steering gear unit 10 may house a gear assembly such as but not limited to rack and pinion gear assembly to transfer motion of steering wheel to wheels of the vehicle. The steering gear unit 10 may also house components to assist and case the motion of steering wheel. In an embodiment, the steering gear unit 10 may house hydraulic components to provide hydraulic assistance for steering the vehicle. The electric motor housing 20 may house an electric motor and a gear assembly to further provide assistance to the steering of the vehicle 400 by selectively drawing power from the electric motor. The electric motor provides power assist to the steering system via hydraulic pressure. Sensors may feed data on driving speed, steering torque, and steering speed to the steering assembly 100 control unit, which calculates the steering assistance. The pump then generates the needed hydraulic pressure, which is directed into a steering cylinder divided into two chambers by a separator piston. Depending on the steering angle and vehicle speed, the steering assembly 100 dynamically adjusts the pressure in each chamber to provide the driver with the appropriate level of steering support. In an embodiment, the electric motor of the electro-hydraulic power assisted steering assembly 100 may be configured to provide more power during maneuvering or low speed of the vehicle 400, so that steering wheel is flexible enough for maneuvering the vehicle 400. On the other hand, when the vehicle 400 is moving at a high speed, the electric motor may be configured to transmit lesser power so that the steering wheel is sturdy. Accordingly, the electric motor housing 20 provides assistance for steering of the vehicle 400.

As shown in FIG. 1, the steering gear unit 10 includes a valve housing 12. Valve housing 12 is bolted on to the steering gear unit 10 and it has a valve arrangement to increase or decrease the oil flow from the hydraulic pump based on the driver input on the steering wheel. In an embodiment, the electric motor housing 20 may be coupled to the steering gear unit 10 through the valve housing 12. As opposed to conventional design, where a separate valve housing 12 design was required depending on the orientation of the electric motor housing 20, in the present disclosure, a single valve housing 12 design may be used for all the different possible orientations of the electric motor housing 20.

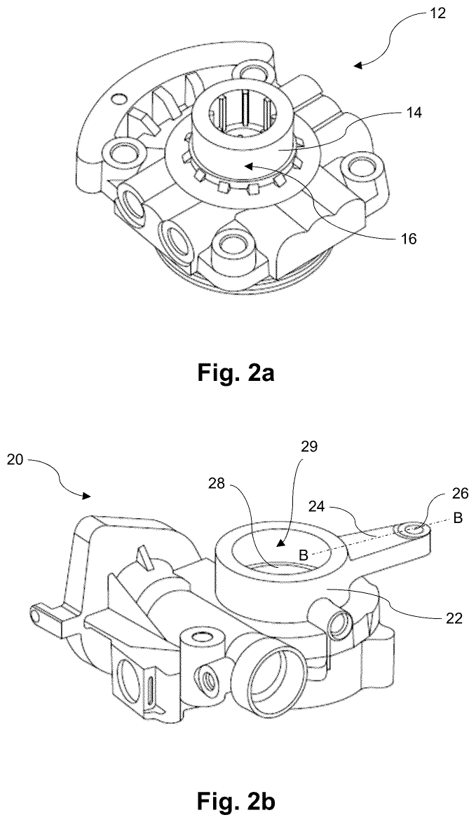

Now referring to FIG. 2a, it illustrates a perspective view of the valve housing 12. The valve housing 12 comprises a first projection 14 extending outwardly from the steering gear unit 10 in a longitudinal direction along a longitudinal axis A-A (indicated in FIG. 1). The first projection 14 may be defined with external threads 16 and during assembly, the first projection 14 may act as a male part. In an embodiment, the valve housing 12 may be of a circular cross-section and the first projection 14 may be of a cylindrical shape. In an embodiment, the entire length of the first projection 14 may be defined with the external threads 16 and in another embodiment, a portion of the length of the first projection 14 may be defined with the external threads 16. As shown in FIG. 2a, the first projection 14 may be at a substantially central portion of the valve housing 12. Further, at peripheral portion of the valve housing 12, there may be a plurality of ports for passage of hydraulic fluid which in turn has a valve arrangement to increase or decrease the oil flow from hydraulic pump based on the driver input on the steering wheel.

Further, FIG. 2b shows a perspective view of a portion of the electric motor housing 20. The electric motor housing 20 comprises a second projection 22 extending outwardly from a body of the electric motor housing 20 in a longitudinal direction along the longitudinal axis A-A (shown in FIG. 1). The second projection 22 may be defined with a bore 28 and the bore in turn defined with internal threads 29. These internal threads 29 may correspond to the external threads 16 of the first projection 14 of the valve housing 12. In an embodiment, the second projection 22 may act like a female part during the assembly. In an embodiment, the second projection 22 may be of a cylindrical shape. In an embodiment, the entire length of the second projection 22 may be defined with the internal threads 29 and in another embodiment, a portion of the length of the second projection 22 may be defined with the internal threads 29. As shown in FIG. 2b, the second projection 22 extending outwardly may be slightly off-set from a central portion of the electric motor housing 20. The electric motor housing 20 further includes an extension arm 24 extending along a lateral axis (B-B) of the electric motor housing 20. In an embodiment, as shown in FIG. 2b, the extension arm 24 may extend laterally from the second projection 22. Farther end of the extension arm 24 from the second projection 22 may be defined with a through hole 26.

Referring back to FIG. 1, the steering assembly 100 further comprises a lock nut 32 and a bolt 34. The lock nut 32 may engage with an external threads 16 of the first projection 14 of the valve housing 12. In one embodiment, the lock nut 32 may be defined with internal threads and it may engage with the external threads 16 of the first projection 14. The lock nut 32 may further be used to apply the clamping load on the electric motor housing 20. Further, the bolt 34 may be inserted along the through hole 26 to fix the orientation of the electric motor housing 20. In an embodiment, the bolt 34 may be inserted along the through hole 26 till it makes frictional contact with the valve housing 12. Such insertion of the bolt 34 may be done upon rotation of the electric motor housing 20 to the orientation as per packaging constraints of the vehicle 400.

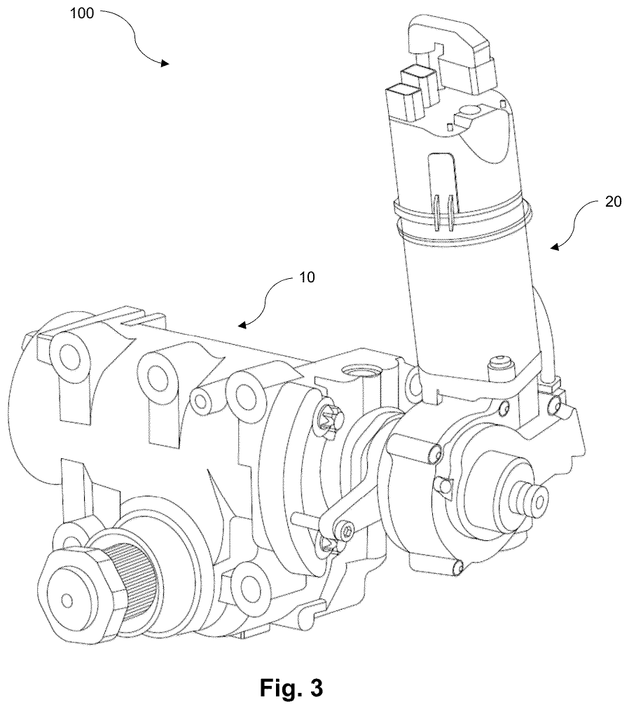

Referring now to FIG. 3 in conjunction with FIG. 1. FIG. 3 illustrates an assembled view of the electro-hydraulic power assisted steering assembly 100. The valve housing 12 of the steering gear unit 10 may be configured such that it can accommodate any orientation of the electric motor housing 20. The orientation of the electric motor housing 20 may range anywhere between 0° to 360°. In an embodiment, the external threads 16 of the first projection 14 of the valve housing 12 acts as a female member and the second projection 22 of the electric motor housing 20 defined with internal threads 29 acts as a male member. The external threads 16 of the first projection 14 and the internal threads 29 of the second projection 22 may engage with each other to couple the electric motor housing 20 with the steering gear unit 10 so as to form the steering assembly 100 as shown in FIG. 3. During assembly, the electric motor housing 20 may be rotated with respect to the steering gear unit 10 and the valve housing 12 to adjust the orientation of the electric motor housing 20. In an embodiment, the valve housing 12 may also be rotatable so as to adjust the orientation of the electric motor housing 20. Further, during rotation of the electric motor housing 20, it may have to be rotated to first achieve a minimum thread engagement between the internal threads 29 of the second projection 22 of the electric motor housing 20 and the external threads 16 of the first projection 14 of the valve housing 12, and then further rotation may be imparted to the electric motor housing 20 to arrive at the orientation of the electric motor housing 20 as per the vehicle packaging constraints. For example, the minimum thread engagement may be 15 threads, and the same is determined based on parameters including length of the first projection 14, the length of the second projection 22, packaging constraints of the vehicle 400 and so on. The numerical value mentioned herein is exemplary and the same should not be construed as a limitation of the present disclosure. In an embodiment, the electric motor housing 20 may be rotated by mechanical means and in another embodiment, the electric motor housing 20 may be rotated by electronic means, however, the way of rotation of the electric motor housing 20 should not be construed as a limitation of the present disclosure.

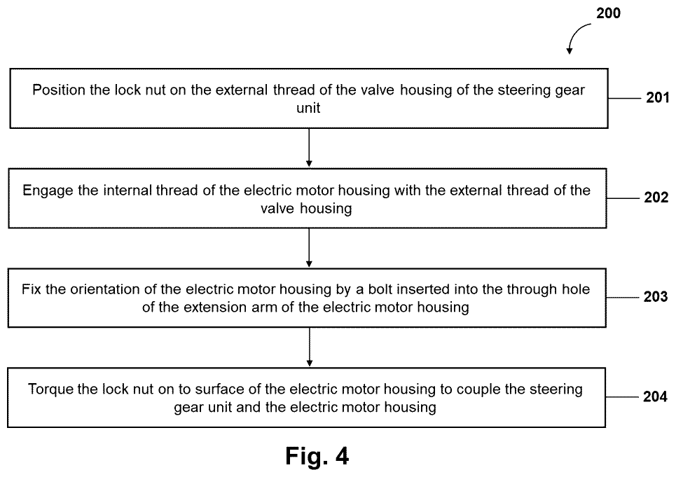

FIG. 4 illustrates a flowchart showing a method 200 for assembling the steering assembly 100, in accordance with some embodiments of the present disclosure.

The order in which the method 200 is described is not intended to be construed as a limitation, and any number of the described method blocks can be combined in any order to implement the method. Additionally, individual blocks may be deleted from the methods without departing from the scope of the subject matter described herein.

At step 201, firstly the lock nut 32 may be positioned on the external threads 16 of the valve housing 12 of the steering gear unit 10. The lock nut 32 in one embodiment may be defined with an internal threads to engage with the external threads 16 of the valve housing 12. The lock nut 32 may be positioned close to the body of the steering gear unit 10.

At step 202, the electric motor housing 20 may be rotated in order to engage the internal threads 29 of the second projection 22 with the external threads 16 of the valve housing 12 of the steering gear unit 10. During engagement, it may be required to ensure that there is at least a minimum thread engagement between the internal threads 29 of the second projection 22 and the external threads 16 of the valve housing 12. During this step, the electric motor housing 20 may be rotated with respect to the valve housing 12 or the steering gear unit 10. In one embodiment, valve housing 12 will be intact with the steering gear unit 10 as it may be already coupled to the steering gear unit 10 using bolted joints.

At step 203, after minimum thread engagement, the orientation of the electric motor housing 20 may be fixed with respect to the steering gear unit 10 by inserting the bolt 34 in the through hole 26 of the extension arm 24 of the electric motor housing 20. In an embodiment, the bolt 34 may be inserted along the through hole 26 till it makes frictional contact with the valve housing 12. Such insertion of the bolt 34 may be done upon rotation of the electric motor housing 20 to the orientation as per packaging constraints of the vehicle 400.

At step 204, upon fixing the orientation of the electric motor housing 20 with respect to the steering gear unit 10, the lock nut 32 may be torqued using a suitable mechanical tool on to a surface of the electric motor housing 20 to couple the steering gear unit 10 with the electric motor housing 20. The torquing of the lock nut 32 against the surface of the electric motor housing 20 ensures that the clamp load is applied.

Referring now to FIG. 5. It illustrates a schematic view of the vehicle 400. The vehicle 400 as shown in FIG. 5 includes a steering system 300 and the electro-hydraulic power assist steering assembly 100. The steering assembly 100 using a unanimous valve housing 12 to accommodate different possible orientations of the electric motor housing 20 as per the present disclosure may be used in the steering system 300 of the vehicle 400. The steering system 300 may include linkage assembly and steering wheel among other components. In an embodiment, input shaft of the electric motor housing 20 may be coupled to the linkage assembly which may be in turn connected to the steering wheel. In an embodiment, the steering wheel may be used to transmit the driver's input torque to the input shaft of the electric motor housing 20 which may in turn be coupled to the steering gear unit 10. Thereby, as per vehicle requirements, torque generated may actually be a combined effect of the steering gear unit 10 using hydraulic power and electric motor housing 20 using electric power.

Some of the technical advantages of the present disclosure is indicated herein below—

The valve housing 12 of the present disclosure is configured such that it may accommodate the electric motor housing 20 in any orientation ranging from 0° to 360° orientation. Thus, a single unanimous valve housing 12 design may be suitable for all the types of the electric motor housing 20. With this, the tool development cost, material cost may be saved. The present disclosure also avoids the necessity of having different variants of the valve housing 12.

Parts unmentioned in the present disclosure may be realized by adopting or referring to the prior art.

### Equivalents

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” While various aspects and embodiments have been disclosed herein, other aspects and embodiments will be apparent to those skilled in the art. The various aspects and embodiments disclosed herein are for purposes of illustration and are not intended to be limiting, with the true scope being indicated by the claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

Reference number Description
100 Electro-hydraulic power assisted steering assembly of a vehicle/Steering assembly
10 Steering gear unit
12 Valve housing
14 First projection
16 External threads
20 Electric motor housing
22 Second projection
24 Extension arm
26 Through hole
28 Bore
29 Internal threads
32 Lock nut
34 Bolt
200 Method of assembling of the electro-hydraulic power assisted steering assembly
201-204 Steps in flowchart
300 Steering system
400 Vehicle

1. An electro-hydraulic power assisted steering assembly for a vehicle, the assembly comprising:
a steering gear unit comprising a valve housing, wherein the valve housing comprises a first projection, the first projection is defined with external threads; and
an electric motor housing comprising a second projection, the second projection is defined using a bore with internal threads corresponding to the external threads of the first projection,
wherein, the external threads of the first projection of the valve housing engage with the internal threads of the second projection of the electric motor housing to couple the steering gear unit with the electric motor housing.

2. The assembly according to claim 1, wherein the first projection and the second projection extends along a longitudinal axis of the steering gear unit and the electric motor housing respectively.

3. The assembly according to claim 2, wherein during the engagement of the external threads of the first projection and the internal threads of the second projection, the electric motor housing is rotatable with respect to the longitudinal axis to adjust an orientation of the electric motor housing with respect to the steering gear unit.

4. The assembly according to claim 3, wherein the orientation of the electric motor housing ranges between 0° to 360° with respect to the steering gear unit.

5. The assembly according to claim 1, wherein the electric motor housing comprises an extension arm extending along a lateral axis of the electric motor housing and the extension arm is defined with a through hole to accommodate a bolt for fixing the orientation of the electric motor housing with respect to the steering gear unit.

6. The assembly according to claim 5, wherein the bolt makes a frictional contact with the valve housing.

7. The assembly according to claim 1 comprises a lock nut being configured to engage with the external threads of the valve housing and is configured to abut with a surface of the electric motor housing.

8. A steering system of the vehicle comprising the electro-hydraulic power assisted steering assembly as claimed in claim 1.

9. A vehicle comprising the electro-hydraulic power assisted steering assembly as claimed in claim 1.

10. A method of assembling the electro-hydraulic power assisted steering assembly according to claim 1, the method comprising:
positioning a lock nut on the external threads of the valve housing of the steering gear unit;
engaging the internal threads of the electric motor housing with the external threads of the valve housing;
fixing the orientation of the electric motor housing by a bolt inserted into a through hole of an extension arm of the electric motor housing, wherein the bolt is in frictional contact with the valve housing; and
torquing the lock nut on to the surface of the electric motor housing to couple the steering gear unit and the electric motor housing.

11. The method according to claim 10, wherein fixing the orientation of the electric motor housing is carried out upon minimum thread engagement between the internal threads of the electric motor housing and the external threads of the valve housing.
